(19) United States
(12) Patent Application Publication
(10) Pub. No.: US 2020/0194142 A1
(43) Pub. Date: Jun. 18, 2020

(54) Metal Matrices and Methods and Systems of Production Thereof

(71) Applicant: William F. Jones, Senca, SC (US)

(72) Inventor: William F. Jones, Senca, SC (US)

(21) Appl. No.: 16/717,191

(22) Filed: Dec. 17, 2019

Related U.S. Application Data
(60) Provisional application No. 62/780,621, filed on Dec. 17, 2018.

(51) Int. Cl. H01B 5/02; H01B 13/00; H01B 1/02; H01B 1/04; B21C 1/02

(52) U.S. Cl. CPC H01B 5/02; H01B 13/0036; B21C 1/02; H01B 1/04; H01B 1/02

(57) ABSTRACT

A method of making a matrix material with particular mechanical and/or physical properties, including providing a mixture of micro and/or nano particle and a cored wire as a feed stock, and physically incorporating the micro and/or nano particles into the cored wire to thereby produce the matrix material. Such method could also include the physical incorporation of the micro and/or nano particles into the cored wire being accomplished using a continuous forming process to thoroughly mix the micro and/or nano particles to thereby produce a dispersion mixture of particles and/or a drawing process through successive dies to process the matrix material. An elongated material is also disclosed, having an exterior portion including a matrix material and a core material generally surrounded by the exterior portion and having particles including one or more micro particles, nano particles, macro or nano matrix material particles and/or a second matrix material.

### FIELD

The present disclosure is generally related to metal matrices and method and system of production thereof, and more specifically, metal matrices having metallic and/or nonmetallic particles for enhancement of material properties, which are mixed into the metal matrix using a continuous forming process, or alternately, using a drawing process.

### BACKGROUND

Metal materials are used extensively in many products used by society. Depending on the specific applications, metals may be used in pure forms, e.g. copper for electrical conductors. However, metals in their pure form have limitations because they lack the necessary strength to provide for efficient use in products. Further, pure metals have limitations in that they may not have suitable resistance to environmental attack to prevent deterioration. Thus, metals are normally supplied as alloys, wherein other elements are mixed into the primary metal to enhance properties such as strength, corrosion resistance, etc. In these alloys the elements used are selected so they mix into the primary metal matrix to provide a solid solution with the primary metal. Elements such as carbon and chrome can be added to iron to increase strength and corrosion resistance. Elements such as zirconium and/or chrome can be added to copper to increase strength. But adding alloying elements to a primary metal can alter the physical properties, i.e. electrical conductivity, thermal conductivity, etc., and thus require changes in how the alloy is used. For example, adding zirconium to copper results in a significant drop in electrical conductivity and thus requires larger cross sections to carry the same current levels as pure copper.

There are technologies involving metal-matrix composites where macro size fibers or particles are dispersed into a liquid metal that is then solidified. In these systems, strength can be increased while not requiring addition of alloying elements that would mix into the metal, forming a solid solution mixture and degrade physical properties. These metal-matrix composites require material combinations where the fibers or particles do not melt or dissolve in the molten metal matrix. Also, solidification needs to happen such that the fiber or particles remain dispersed in the solidified composite.

Research tends to indicate that if micro and/or nano particles can be introduced and dispersed into a solid metal matrix, then strength and physical properties can be altered to provide specific properties. By introducing micro and/or nano particles into the metal matrix. during mechanical flow of the metal, without the need to melt the metal, then more options exist for types and shapes of particles that can be introduced. This then allows for customization of properties using different particles. The micro and/or nano particles would not need to form bonds with the metal matrix lattice; however, if bonds were formed this would provide benefits also.

Prior art for introduction of micro and/or nano particles involve a variety of techniques but each is some form of a batch process. Mixing into a liquid and solidifying. Growing metal layers by electrochemical processes around the particles and subsequently processing is another. What is needed is a process that can be a continuous process that produces sizes and shapes that are suitable for use in structures and components of consumer use.

Accordingly, disclosed herein is a process for continuously introducing micro and/or nano particles into a metal matrix while producing commercial shapes.

### SUMMARY

In one aspect, a system is described herein for continuous production of specialized particle mixtures of particles metallic and/or nonmetallic particles for enhancement of material properties.

In another aspect, a method is described herein for continuous production of specialized particle mixtures of particles, metallic and/or nonmetallic particles, for enhancement of material properties.

In a further aspect, a system and a method are described herein for continuous production of specialized particle mixtures of particles, metallic and/or nonmetallic particles, of sizes, in one non-limiting example, ranging from 0.1 nm to 500 μm in a metal matrix for enhancement of material properties.

In a still further aspect, a system and a method are described herein for continuous production of specialized particle mixtures of particles, metallic and/or nonmetallic particles, wherein such particles are mixed into a metal matrix using a continuous forming process, which in one example implementation, includes the “conform” process.

In yet a further aspect, a system and a method are described herein for continuous production of specialized mixtures of particles, metallic and/or nonmetallic particles, wherein such particles are placed in the center of a cored wire in applications where property enhancement is desired in the shell of the wire.

In another aspect, a system and a method are described herein for continuous production of specialized mixtures of particles, metallic and/or nonmetallic particles, wherein such particles are placed in the center of a cored wire, and metal particles of a first or a second metal can be added to the center of the cored wire along with micro and/or nano particles to aid in mixing and distribution of the micro and/or nano particles and/or to increase product output.

In yet another aspect, a system and a method are described herein for continuous production of specialized mixtures of particles, metallic and/or nonmetallic particles, wherein such particles are placed in the center of a cored feed wire, and the cored feed wire can contain either a single core with a shell of matrix metal wrapped around or it could include a spiral wrapping, with micro and/or nano particles and any metallic filler placed between or within the windings, or wraps of the matrix metal.

In a further aspect, a system and a method are described herein for continuous production of specialized mixtures of particles, metallic and/or nonmetallic particles, wherein a cored feed wire is fed through dies to reduce the cross section while distributing micro and/or nano particles in a matrix material.

In one aspect, a system and a method are described herein for continuous production of specialized mixtures of particles, metallic and/or nonmetallic particles, wherein a cored feed wire is fed through dies to reduce the cross section while distributing micro and/or nano particles in a matrix material, thereby allowing for wire having a center region with a higher concentration of the micro and/or nano particles.

In a further aspect, a method for varying one or more properties of a cored wire includes providing a mixture of micro and/or nano particles; providing a feed stock of a cored wire; and physically incorporating the micro and/or nano particles into the cored wire to thereby produce the matrix material. Other aspects of the method include the incorporation of the micro and/or nano particles into the cored wire involving use of a continuous forming process to thoroughly mix the micro and/or nano particles to thereby produce a dispersion mixture of particles. Further aspects of the method include using a drawing process through successive dies to process the cored wire.

In a further aspect, an elongated cored feed stock material is disclosed having an exterior portion, or wrapper, including a matrix material and a core material generally surrounded by the wrapper and having particles including one or more micro particles, nano particles, macro or nano matrix material particles and/or a second matrix material. Other aspects of the feed stock include the wrapper being wound as a spiral along the length of the feed stock material to form a wire with the particles between or within the wraps of the spiral and/or the second matrix material in the core material produces an inner material with enhanced properties and an outer layer with different properties. In yet another aspect, a method is disclosed of making a matrix material, including providing a particle mixture of micro and/or nano particles and a cored wire as a feed stock, and physically incorporating the micro and/or nano particles into the cored wire to thereby produce the matrix material. Such method could also include the physical incorporation of the micro and/or nano particles into the cored wire being accomplished using a continuous forming process to thoroughly mix the micro and/or nano particles to thereby produce a dispersion mixture of particles and/or a drawing process through successive dies to process the matrix material.

In a still further aspect, an elongated material is disclosed having an exterior portion including a matrix material and a core material generally surrounded by the exterior portion and having particles including one or more micro particles, nano particles, macro or nano matrix material particles and/or a second matrix material. Such elongated material may also include the exterior portion being wound as a spiral along the length of the feed stock material to form a wire with the one or more micro particles, nano particles, macro or nano matrix material particles and/or a second matrix material being between or within the windings of the spiral. Further, such elongated material may include the second matrix material in the core material being configured to produce an inner material with first material properties and an outer layer with second material properties, and the second material properties differing from the first material properties.

The features, functions, and advantages that have been discussed can be achieved independently in various examples or may be combined in yet other examples, further details of which can be seen with reference to the following description and drawings.

### BRIEF DESCRIPTION OF THE DRAWINGS

Having thus described exemplary aspects of the disclosure in general terms, various features and attendant advantages of the disclosed concepts will become more fully appreciated as the same becomes better understood when considered in conjunction with the accompanying drawings, which are not necessarily drawn to scale, in which like reference characters designate the same or similar parts throughout the several views, and wherein:

FIG. 1 is a schematic view of an exemplary cored wire in accordance with the present disclosure;

FIG. 2 is a schematic view of an exemplary spiral wound cored wire in accordance with the present disclosure;

FIG. 3 is a schematic view of an exemplary continuous cored wire forming system in accordance with the present disclosure;

FIG. 4A is a schematic view of an exemplary cored wire feedstock in accordance with the present disclosure;

FIG. 4B is a schematic view of an exemplary cored wire having micro and/or nano particles mixed in a matrix material in accordance with the present disclosure;

FIG. 5A is a schematic view of an exemplary cored wire feedstock in accordance with an alternate implementation of the present disclosure; and

FIG. 5B is a schematic view of an exemplary wire having micro and/or nano particles mixed in a matrix material in an outer shell of the wire in accordance with the present disclosure.

### DETAILED DESCRIPTION

Examples of the present disclosure will now be described more fully hereinafter with reference to the accompanying drawings, in which some, but not all examples of the disclosure are shown. Indeed, various exemplary aspects of the disclosure may be embodied in many different forms and should not be construed as limited to the examples set forth herein. Rather, these examples are provided so that this disclosure will be thorough and complete and will fully convey the scope of the disclosure to those skilled in the art. Like reference numerals refer to like elements throughout.

The systems and/or methods described herein include metal matrices and methods and systems of production thereof and more specifically, metal matrices having metallic and/or nonmetallic particles for enhancement of material properties, which are mixed into the metal matrix using a continuous forming process, or alternately, using a drawing process.

Implementations of the present disclosure are more particularly described herein along with examples that are intended to be illustratively only, since numerous modifications and variations therein will be apparent to those skilled in the art. As used in this document, the singular form “a”, “an” and “the” may include plural referents unless the context clearly dictates otherwise. Also, as used in this document, the term “comprising” may include the expressions “consisting of” and “consisting essentially of.”

Referring now to the drawings in detail, an exemplary metal matrix material surrounding a core of particles of an implementation of the present disclosure is indicated generally in FIG. 1 by reference numeral 100. In a particular implementation, metal matrix product 100 is a wire, and in particular, a cored wire. In other suitable implementations, metal matrix product 100 may be other shapes or forms suitable for continuous forming processing.

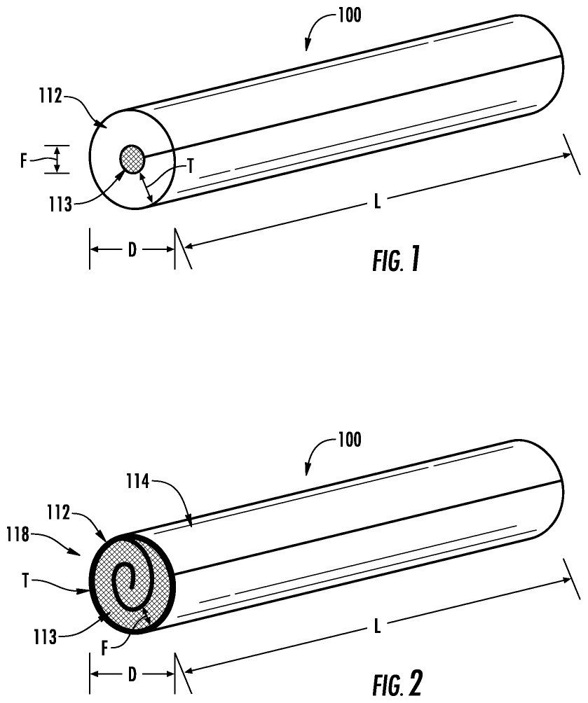

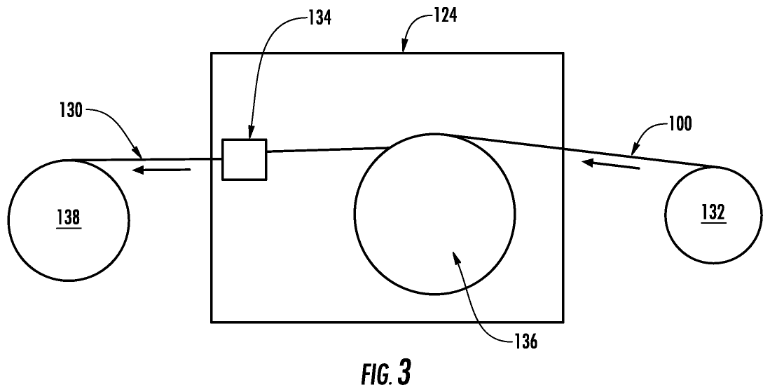

An implementation of the present disclosure provides a method of creating specialized particle mixtures of materials, e.g. metals and particles, to enhance and improve properties of a matrix material (e.g. metal) without the need to alloy or dissolve into solid solution with the matrix material. This implementation utilizes a continuous forming process (such as the Con-Form process), shown schematically in FIG. 3, and a cored wire feed stock, generally 100 (shown in FIGS. 1 and 2), to create the particle mixtures and dispersion of particles through plastic mechanical deformation and solid flow of the matrix material, generally 112, and the particles 113 (not shown in detail) without melting of the materials. Melting, diffusion or atomic bonding is not generally required of the matrix material and the particles, although the particles may atomically bond to the matrix material during the process.

In FIG. 1, the diameter of metal matrix product 100 is expressed as D (which could, in certain non-limiting examples, be between approximately 0.1 and 0.5 inches); the diameter of particles consisting of micro and/or nano particles and/or metallic particles 113 (collectively, the “particles”) is expressed as F; the thickness of the matrix material layer 112 is expressed as T; and the length of the metal matrix product 100, here a cored wire feed stock, is expressed as L. To create and optimize the concentration of the particles, the F and D dimensions are selectively varied.

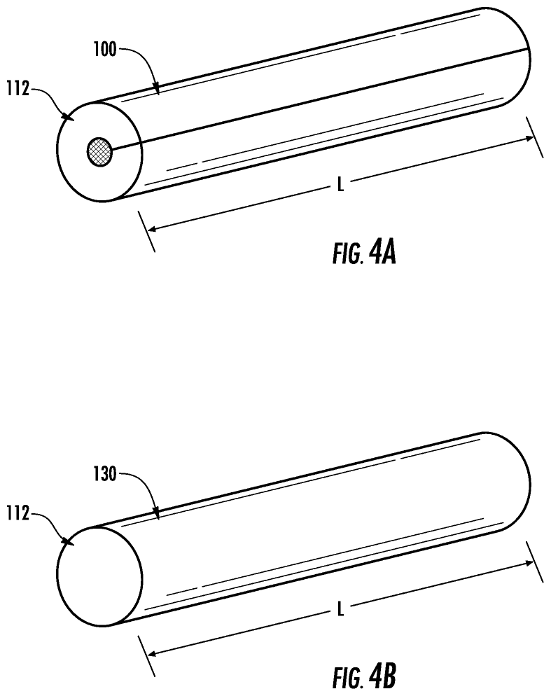

By dispersing the micro and/or nano particles in the matrix material 112 through mechanical flow, the material properties such as strength, electrical conductivity, etc. and/or combinations thereof, can be altered without the detrimental effects as often found with creating a metal alloy. The mixed particles would be of such a nature that they would not be seen by examination of the cross-section of the final product 130 (FIG. 4B) without using high magnification.

The Con-Form (or Conform®, a registered trademark of BWE Limited, Kent, UK) process is a commercially proven and mature process used in the production of various sizes and shapes of copper materials. Example implementation of the Con-Form process is disclosed in U.S. Pat. No. 8,281,634, issue Oct. 9, 2012 to Hawkes, and U.S. Pat. No. 5,503,796, issued Apr. 2, 1996 to Sinha et al., such patents being incorporated in their entirety herein by reference. In the Con-Form process, feed stock of a relatively small round cross section is fed into a die with a large amount of three. The design of the die and the input speed controls filling of a die cavity, such that a larger cross-section shape can be produced. It is not uncommon for a round feed stock to be fed into the Con-Form equipment to produce a rectangular cross section of a larger cross-section then the feed stock. During the conform process, friction from the large amount of mechanical deformation produces heat that assists with flow of the materials but does not cause melting. Thus, the high temperature region of the process is preferably located in a controlled environment to reduce the chance of oxidation.

As shown schematically in FIG. 3, an implementation of a system of the present disclosure includes a Con-Form device, generally 124, into which elongated feed stock material (FIG. 1 or 2), generally 100, containing mixed particles and matrix material, which pays out from a spool 132 or other arrangement. The matrix material is pushed into a process die 134 in the Con-Form device via a feed drive wheel 136 also in the device, and the particles and feed stock material are mixed in the die. After such mixing, the resulting matrix material 130, now containing the particles and a generally solid cross-section (FIG. 4B), is withdrawn onto a take-up spool 138.

Using standard industry practices (as used to manufacture cored welding wire), the feed stock for the Con-Form process, as disclosed herein, is manufactured with the micro and/or nano particles in the center, with the matrix material comprising the outer shell of the feed stock. Shell material thickness can be varied as needed relative the amount of core material to achieve mixtures with concentrations of each component selected to yield optimum property enhancement. Matrix material particles could also be added to the core micro and/or nano particles to improve process yield and concentrations of particles. The feed stock could also be produced as a spiral wound wire 114, as shown in FIG. 2, with the particles inserted between or within the matrix material layers 118 of the spiral wound wire 114 of the matrix material 112.

In FIG. 2, the diameter of metal matrix product 100 is expressed as D (which could, in certain non-limiting examples, be a spiral wound wire 114); the thickness of particles between or within layers 118 is expressed as F; the thickness of the matrix material shell 112 is expressed as T; and the length of the metal matrix product 100, here a cored wire feed stock, is expressed as L. To create and optimize the concentration of the particles, the F, T, and D dimensions are selectively varied.

In the cored wire feed stock material, the micro and/or nano particles and any additional metallic fillers would ordinarily be observable in a cross-section of the wire, FIG. 4A. However, after mixing of the core materials 113 and the matrix material 112 by the Con-Form process the particles would generally not be observable without using high magnification, FIG. 4B. At high magnification, the micro and/or nano particles would be observable as discrete particles with and without boundaries between them and the matrix material.

Con-Form differs from other processes, such as extrusion. With extrusion, a larger cross-section billet of material is ordinarily produced by melting and rolling. This billet is then pressed through a die to produce the desired final cross-section. The billet can be extruded at ambient temperature or heated. In extrusion the feed material cross section is larger than the final product cross section, and micro and/or nano particles are not ordinarily introduced into the final cross-section. Further, the extrusion process is a batch process, and is thus limited by the quantity of material in each billet. Additionally, Con-Form differs from rolling of materials where a larger size is reduced in cross section by mechanical deformation.

Con Form also differs front drawing, which involves taking feed stock of a certain geometry and pulling it through a series of dies to produce a smaller, final shape with the dimensions required for a particular application. Drawing is performed in a manner such that the material is decreased in size through mechanical deformation in small increments in order to prevent tearing of the material. Drawing can generally be performed at ambient temperature or with heating.

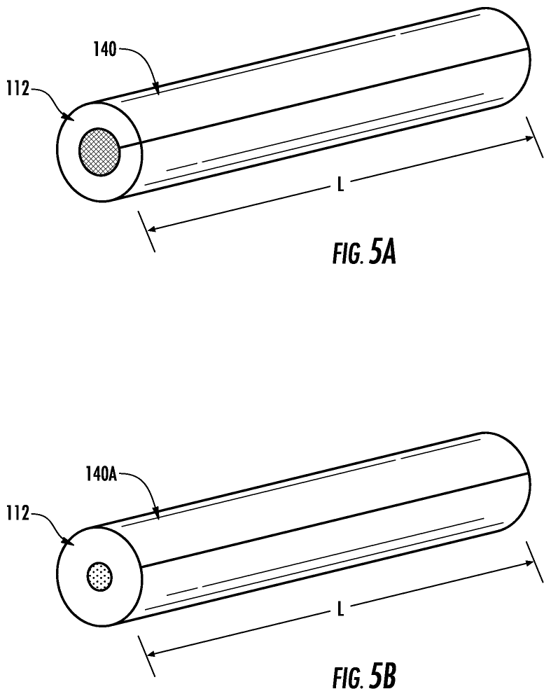

An alternative implementation of the present disclosure includes using the drawing process. The method includes taking cored feed stock wire 140 (FIG. 5A) and feeding it into a series of drawing dies to distribute the micro and/or nano particles into the matrix material. Drawing would not result in an extreme amount of material flow. Thus, the concentration of particles could vary from the center to the outside on the final product 140A, as shown in FIG. 5B. The final product 140A includes matrix outer shell 112 material with an enriched and/or separate center. By using a drawing process, it is possible to design a reduction process that would give a center core of a micro and/or nano particle modified matrix material that is richer in the desired material-enhancing particles, to therefore produce a higher degree of enhancement of the matrix material's properties. Further, a second matrix material could be added to the mixture of particles, which could then produce a product with enhanced properties in the center with an outer shell that provides different characteristics. For example, a copper/carbon nano tube core could be produced with a bronze outer jacket to increase the strength of the wire or other product (not shown) while maintaining high electrical conductivity.

In another patent, U.S. Pat. No. 8,298,480, issued to Jones, et al, and incorporated in its entirety by reference thereto, the use of friction stir welding is described as a method to distribute micro and nano particles into a metal matrix to enhance properties locally or along a length. However, such friction stir welding process is not a process that is considered continuous and instead relies on batches. Additionally, using such friction stir welding process, the micro and/or nano particles would need to be located in grooves or other indentations so that the spinning stir welding tool could mix them into the matrix materials. Further, because of the spinning action of the friction stir welding tool, the location of the micro and/or nano particles would tend to migrate to different regions of the stirred material and would not be distributed through the cross-section. In the case friction stir welding mixing of micro and/or nano particles, further separate processing would be needed to produce commercially usable materials.

In the process of the alternative implementation, where the cored wire is drawn, the mixing mechanism differs from that of the friction stir welding, because drawing is a continuous process that produces a commercially usable product with the micro and/or nano particles being distributed in known locations.

The unique features of the Con-Form process allow for extreme amounts of material deformation and flow without such material melting or transitioning through a liquid phase, thereby allowing a typically larger cross section to be achieved that is in a commercially usable form. This flowing of the material distributes the micro and/or nano particles throughout the new cross-section exiting the Con-Form die. Further, the Con-Form process is a continuous process limited, in a certain sense, only by the life of the die and quantity of feed stock.

A non-limiting example product formed using the Con-Form or cored wire drawing process of the present disclosure could be to introduce carbon nano tubes into a copper metal matrix to increase electrical conductivity. Carbon nano tubes are known to have high electrical conductivity, and could potentially be used to produce “wires” of carbon nano tubes for use as electrical conductors. However, it would be difficult to make such nano tubes into continuous conductors, due to the complexities of working with the nano tubes. Some success may be achieved using weaving techniques. However, conductors produced by this process could be very expensive and fragile. Wires produced by the processes disclosed herein should be expected to have subsequent handling and processing characteristics similar to those of traditional wires.

Difficulties arise in attempting to introduce carbon nano tubes into copper using a variety of chemical and electro chemical processes, and some results indicate that carbon nano tubes may have lower thermal conductivity than copper, and thus offsetting any improvements in electrical conductivity if the carbon nano tubes are in discrete layers. in contrast, the systems and methods of the present disclosure could overcome the limitations of other processing by having the carbon nano tubes dispersed in a copper matrix, which would thus allow for conventional wire manufacture and processing. Further, any decrease in thermal conductivity of the carbon nano tubes could potentially be overcome by allowing the heat to be dissipated through the copper matrix. U.S. Pat. No. 7,651,766, issued to Chen discloses use of carbon nano tubes in copper to increase electrical conductivity, and such patent is hereby incorporated in its entirety by reference.

Although specific features of various examples of the present disclosure may be shown in some drawings and not in others, this is for convenience only. In accordance with the principles of the disclosure, any feature of a drawing may be referenced and/or claimed in combination with any feature of any other drawing.

This written description uses examples to disclose various examples, which include the best mode, to enable any person skilled in the art to practice those examples, including making and using any devices or systems and performing any incorporated methods. The patentable scope is defined by the claims, and may include other examples that occur to those skilled in the art. Such other examples are intended to be within the scope of the claims if they have structural elements and/or components that do not differ from the literal language of the claims, or if they include equivalent structural elements and/or components with insubstantial differences from the literal languages of the claims.

What is claimed is:

1. A method of making a matrix material, the method comprising:
providing a particle mixture of at least one of micro particles and nano particles;
providing a cored wire as a feed stock; and
physically incorporating the particle mixture into the cored wire to thereby produce the matrix material.

2. The method of claim 1, wherein the physical incorporation of the particle mixture into the cored wire to thereby produce the matrix material includes using a continuous forming process to thoroughly mix the at least one of micro particles and nano particles, to thereby produce a dispersion mixture of the particle mixture.

3. The method of claim 1, wherein the physical incorporation of the particle mixture into the cored wire includes using a drawing process through successive dies to process the matrix material.

4. The method of claim 1, wherein the particle mixture includes at least one of metallic particles and nonmetallic particles of sizes ranging from 0.1 nm to 500 μm and being configured for enhancement of at least one of conductivity and strength of the cored wire.

5. The method of claim 1, wherein the particle mixture includes at least one of metallic particles and nonmetallic particles.

6. The method of claim 1, wherein:
the particle mixture includes at least one of metallic particles and nonmetallic particles; and
the particle mixture is placed in the center of the cored wire in applications for enhancement of at least one of conductivity and strength in the shell of the wire.

7. The method of claim 1, wherein the particle mixture is placed in the center of the cored wire in applications for enhancement of at least one of conductivity and strength in the shell of the wire.

8. The method of claim 1, wherein:
the particle mixture includes at least one of metallic particles and nonmetallic particles;
such particle mixture is placed in the center of the cored wire; and
the metallic particles include first metallic particles and second metallic particles of a different type than the first metallic particles being added to the center of the cored wire to aid in mixing and distribution of the at least one of micro particles and nano particles in the particle mixture.

9. The method of claim 1, wherein:
the particle mixture includes at least one of metallic particles and nonmetallic particles;
such particle mixture is placed in the center of a cored wire; and
the cored wire can include either a single core with a shell of at least one matrix metal wrapper or at least one spiral wrapper with micro particles or nano particles and metallic filler placed within the at least one matrix metal wrapper or spiral wrapper, respectively.

10. The method of claim 1, wherein:
the particle mixture includes the at least one of metallic particles and nonmetallic particles;
the particle mixture is placed in the center of the cored wire; and
the cored wire includes a single core with a shell of a matrix metal wrapper or a spiral wrapper.

11. The method of claim 1, wherein:
the particle mixture includes at least one of metallic particles and nonmetallic particles;
the particle mixture is placed in the center of the cored wire; and
the cored wire is fed through dies to reduce the cross section of the cored wire in order to distribute the particle mixture in the matrix material, thereby providing the cored wire with a center region of higher concentration of the at least one of micro particles and nano particles.

12. An elongated material, comprising:
an exterior portion including a matrix material; and
a core material generally surrounded by the exterior portion and having particles including one or more micro particles, nano particles, macro particles or nano matrix material particles and/or a second matrix material.

13. The elongated material of claim 12, wherein the exterior portion is wound as a spiral along the length of the feed stock material to form a wire with the one or more micro particles, nano particles, macro or nano matrix material particles and/or a second matrix material being between the windings.

14. The elongated material of claim 12, wherein the second matrix material in the core material includes an inner material with first material properties and an outer layer with second material properties differing from the first material properties.

15. A method of making a matrix material, the method comprising:
providing a particle mixture of at least one of micro particles and nano particles and at least one of metallic particles and nonmetallic particles;
providing a cored wire as a feed stock;
physically incorporating the particle mixture into the cored wire to thereby produce the matrix material using a continuous forming process to thoroughly mix the at least one of micro particles and nano particles, to thereby produce a dispersion mixture of the particle mixture, and
wherein the particle mixture is placed in the center of a cored wire to enhance at least one of conductivity and strength of the cored wire.
